(19) United States
(12) Patent Application Publication
(10) Pub. No.: US 2008/0211384 A1
(43) Pub. Date: Sep. 4, 2008

(54) Field Emission Display and Glass Frit

(76) Inventors: Yuichi Sawai, Miyazaki (JP); Osamu Shiono, Hitachi (JP); Takashi Naito, Funabashi (JP); Akira Hatori, Chiba (JP); Hiroki Yamamoto, Hitachi (JP); Hirochi Ito, Chiba (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 12/018,462

(22) Filed: Jan. 23, 2008

(30) Foreign Application Priority Data
Feb. 1, 2007 (JP) 2007-022943
Mar. 1, 2007 (JP) 2007-051387

(51) Int. Cl. H01J 1/62; H01J 1/88; C03C 8/00

(52) U.S. Cl. 313/495; 313/292; 501/21

(57) ABSTRACT

Constituent elements of a glass frit for fixing spacers propagate along the spacers and migrate to electron emitters to deteriorate the electron emitters, and thereby silhouetting shadows of the spacers on a screen are suppressed. In an image display which is equipped with a rear substrate provided on its inner surface with electron emitters, a front substrate facing the rear substrate, provided on its inner surface with a phosphor pattern having an array corresponding to the electron emitters, and having an outer surface serving as a display surface, and in which a gap between the substrates is held by glass-made spacers, propagation along the spacers and migration to the side of the electron emitters of the constituent elements of the glass frit for fixing spacers is prevented by fixing oxide crystal particles on the spacer surface, or by fixing at least a part of the spacer to the front panel by an adhesive layer comprising a conductive glass a part of which is crystallized.

### BACKGROUND OF THE INVENTION

The present invention relates to an image display and a spacer used in the same.

Various types of so-called flat panel display (FPD) in which a flat rear substrate and a flat front substrate are laminated are known. For example, flat panel displays having electron emitters arranged in a matrix form draw attention, and as one of them, field emission displays (FED) utilizing minute integrative cold cathodes, and electron emission displays are known. Cathodes of these image displays use a Spindt-type electron emitter, a surface conductive type electron emitter, a carbon nanotube type electron emitter, or a thin film type electron emitter such as an MIM (Metal-Insulator-Metal) type obtained by laminating a metal, an insulator and a metal, an MIS (Metal-Insulator-Semiconductor) type obtained by laminating a metal, an insulator and a semiconductor, or a Metal-Insulator-Semiconductor-Metal type.

In emissive FPDs, a rear substrate equipped with electron emitters like those described above and a front substrate equipped with phosphor layers and an anode forming an acceleration voltage to cause electrons emitted from the electron emitters to impinge on the phosphor layers are laminated, and an internal space through which both the panels face each other is sealed in a predetermined vacuum state. The rear substrate is equipped with a large number of electron emitters in a matrix array, and the front substrate is equipped with phosphor layers and an anode forming an acceleration voltage to form an electric field to cause electrons emitted from the electron emitters to impinge on the phosphor layers.

An individual electron emitter makes a pair with a corresponding phosphor layer to constitute a unit pixel. Commonly, unit pixels of three colors, red (R), green (G) and blue (B), constitutes one pixel (color pixel). In the case of color pixels, a unit pixel is also called a subpixel.

The rear substrate and the front substrate are held with a predetermined gap by partition holding members called spacers arranged so as to hold both the substrates in a display region. The spacers comprise a plate formed of a member having a conductivity in some degree such as glass or ceramic, and are commonly installed in every plural pixels at positions where the operation of the pixels are not disturbed.

Spacers are arranged with an equal gap to keep two substrates parallel. As a spacer, one is know in which an antistatic film of 10⁸ to 10¹⁰ Ω/□ in surface resistance is provided on the surface of an insulating glass substrate.

As the antistatic film, a film having conductive particles formed like islands on a high-resistance film is described in Patent Document 1; an alloy oxide film of a transition metal and cobalt or a nitride film in Patent Document 2; a film constituted of Cr, Al nitride and conductive particles in Patent Document 3; and a film whose substrate partially is exposed in Patent Document 4.
Patent Document 1: JP-A-2000-113997
Patent Document 2: JP-A-2005-317246
Patent Document 3: JP-A-2005-235751
Patent Document 4: JP-A-10-284285

In an image display fabricated using spacers having an antistatic film on their surface, the spacers have no electrostatic charge, therefore, images are displayed with no curved orbit of electrons emitted from electron emitters.

However, an image display equipped with spacers has such a problem that the shadow of the spacer is silhouetted on a screen. The problem cannot be eliminated even in the image display having an antistatic film on its surface. The cause is the contamination of electron emitters by a spacer fixing frit to fix a spacer to a substrate.

A spacer is adhered to a front substrate using a spacer fixing frit and adhered or pressed to a rear substrate using a spacer fixing frit. Constituent elements of the spacer fixing frit propagate along the spacer surface, migrate and diffuse to electron emitters, and contaminate and deteriorate the electron emitters. Thereby, the shadow of the spacer is silhouetted on a screen.

As a spacer fixing frit, a mixture of a Pb-based glass frit with conductive particles has been conventionally used. However, according to the enforcement of the RoHS Directive, Pb-based glass frits cannot be used and V-based glasses, Sn-based glasses or Bi-based glasses have been recently used as alternatives.

However, use of lead-free glasses such as V-based glasses, Sn-based glasses or Bi-based glasses contaminates and deteriorates electron emitters by elements constituting the glass frit.

For example, when a spacer is fixed to a front substrate and a rear substrate using a lead-free glass, the number of electron emitters being deteriorated increases in the electron emitters between in the vicinity of the spacer and up to the third or fourth line, and consequently, the shadow of the spacer is silhouetted on a screen.

Further, for example, when a spacer is fixed to a front substrate side using a lead-free glass and is pressed and fixed on a rear substrate side having electron emitters, although the deterioration of the electron emitters is less than that in the above-mentioned example, electron emitters between in the vicinity of the spacer and up to the first or second line deteriorate, whereby the shadow of the spacer is silhouetted on a screen. This is because constituent elements of the lead-free glass present on the front substrate side propagate along the spacer surface and migrate to the rear substrate side.

Even when a Pb-based glass frit is used, ingredients constituting the glass frit similarly cause the contamination of electron emitters though not so much as in the use of a lead-free glass frit, whereby the shadow of the spacer is silhouetted on a screen.

It is an object of the present invention to provide a field emission display in which the propagation along the spacers and migration to electron emitters of constituent elements of a glass frit to fix spacers are suppressed; and the contamination of spacers and electron emitters by diffusion of a glass adhesive to fix the spacers is suppressed; and thereby providing high-quality images.

### SUMMARY OF THE INVENTION

The featuring points of the present invention lie in the use of a glass containing crystal particles as a material for fabricating an image display. By attaching a glass having crystal particles to the surface of a spacer, or by using the glass as a glass adhesive to fix a spacer, the glass adhesive to fix the spacer is prevented from diffusing and contaminating the circumference.

A first aspect of the present invention is an image display comprising a rear substrate provided with electron emitters on its inner surface, a front substrate facing the rear substrate, provided on an inner surface thereof with phosphor layers having an array corresponding to the electron emitters, and having an outer surface serving as a display surface, glass-made spacers holding a gap between the rear substrate and the front substrate and adhered at least to the inner surface of the front substrate by using a spacer fixing frit; and a sealing frame sealing a periphery of a spacial part between the rear substrate and the front substrate, in which the oxide crystal particles are provided on a surface of the spacer.

Further, the present invention has a feature wherein the glass-made spacers holding the gap between the rear substrate and the front substrate in the image display have oxide crystal particles on their surfaces.

Any method for fixing the oxide crystal particles on the surfaces of the spacers can be used and is not limited. For example, a method may involve mounting the oxide crystal particles on the surface of a glass substrate constituting a spacer and heating to a softening temperature of the glass substrate to fix the particles. A method may involve fixing the oxide crystal particles to a spacer by using a glass adhesive. The method using a glass adhesive is preferable because the fixing operation of oxide crystal particles is easily carried out, and besides, the particles can surely be fixed.

Oxide crystal particles of not less than 0.1 μm and not more than 50 μm in particle size preferably account for not less than 90% of the oxide crystal particles on each spacer surface.

A covering rate with the oxide crystal particles of a spacer surface is preferably 10 to 100%.

A surface roughness of each spacer having the oxide crystal particles is preferably not less than 0.1 μm and not more than 50 μm.

An attachment form of the oxide crystal particles on each spacer surface may be one in which the particles are dispersed and disposed like isolated islands or may be one in which the particles are attached like continuous stripes as long as the above-mentioned conditions are satisfied.

A technique for attaching the oxide crystal particles on each spacer surface involves spray coating. This technique involves fabricating a spray liquid containing several percents to several tens percents of the oxide crystal particles and spraying the liquid to a spacer. The spray liquid may contain a glass ingredient to more firmly fix the oxide crystal particles.

In the case of fabricating the spacers in a drawing process of a glass preform, a glass perform on which oxide crystals are previously provided is drawn to obtain a spacer having the oxide crystal particles on its surface. For example, a paste containing the oxide crystal particles is printed like stripes, on a glass preform in advance, and a spacer on the surface of which the oxide crystal particles are disposed like stripes is thereby obtained. The paste containing the oxide crystal particles may contain a glass ingredient to more firmly fix the oxide crystal particles.

An oxide containing vanadium and phosphorus is remarkably preferable as the oxide crystal particles fixed on each spacer surface. Other examples of the oxide crystal particles preferably include those selected from CoO, CuO, Fe₂O₃, MnO, Zr₂O₃, Y₂O₃, Nd₂O₃, Gd₂O₃, ZnO, V₂O₅ and Sb₂O₅. These may be used alone or as a mixture.

A surface resistance of each spacer having the oxide crystal particles on its surface is preferably in the range of 10⁸ to 10¹² Ω/□.

The oxide crystal particles fixed on each spacer surface function as an obstacle to obstruct the propagation along the spacers and the migration and diffusion to the electron emitters of elements constituting the spacer fixing frit. Thereby, the elements constituting the spacer fixing frit are prevented from moving and deteriorating the electron emitters and the decrease in the image quality caused by this can be prevented.

A second aspect of the present invention is a field emission display comprising a rear panel comprising a glass substrate on which electron emitters to emit electrons are formed; a front panel comprising a glass substrate on which phosphors to emit light by irradiation of an electron beam are formed; and a plurality of spacers arranged between the front panel and the rear panel wherein the spacers are conductive and at least partially fixed to the front panel by an adhesive layer comprising a partially crystallized glass.

The feature of the present invention lies in that when a spacer is fixed, a glass adhesive containing amorphous glass portions and crystalline portions, i.e., crystal phase portions is used.

The crystalline portions have a higher melting point than the amorphous glass portions, and function to reduce the diffusion of the adhesive. Further, since constituent elements of the crystal phase are more strongly bound to the base material of the adhesive than constituent elements of the amorphous glass, the dissociation and scatter of the glass constituent elements can be prevented and the contamination of the spacers and the electron emitters can be reduced. Therefore, the more content of the crystal phase gives a glass adhesive with less contamination. It is especially preferable that the content of the crystal phase be not less than 50 vol % and not more than 95 vol %.

Fixing of the spacers using a glass frit or a glass paste as a raw material of an adhesive is an easy way. In this case, the adhesive is preferably a glass which does not contain crystals at the stage of frit and the like and in which crystals are deposited when the glass melts by heat when the spacers are fixed. As a result, the strength of the spacer fixation can be held and the diffusion of the adhesive can be prevented.

Here, the glass frit means a glass powder obtained by blending raw materials of a glass, melting them at a high temperature and then quenching the melt, and the glass paste means a mixture of a frit and a liquid ingredient.

The adhesive and the glass frit for fixing the spacers in the present invention preferably contains V₂O₅ or V₂O₅ and P₂O₅ as main ingredients. The glass frit is especially preferably a glass containing, at least, V₂O₅ at 50 to 60 wt %, P₂O₅ at 15 to 25 wt % and ZnO at 10 to 30 wt %. For making a conductive glass, V₂O₅ is necessary. Deviation of V₂O₅ and P₂O₅ from the above range does not form a glass. ZnO is contained for adjusting the electric resistance of the glass and promoting the crystallization. With ZnO at less than 10 wt %, the crystallization is insufficient, and with ZnO exceeding 30 wt %, the adhesive force of the spacers decreases.

The adhesive has an electric resistivity of not more than 10⁹ Ωcm and is made of a glass at least a part of which is crystallized. Ordinal glass spacers have an electric resistivity of 10⁹ Ωcm; by contrast, wiring formed on a glass substrate constituting a rear panel has an electric resistivity of 0 Ωcm. Therefore, the adhesive preferably has an electric resistivity of more than 0 Ωcm and less than 10⁹ Ωcm for preventing the electrification of the spacers.

The present invention provides a glass frit comprising a glass ingredient constituting a conductive glass and a crystallizing ingredient to react with a part of the glass constituting ingredient and form a crystal phase. The glass frit of the present invention preferably contains V₂O₅ at 50 to 60 wt %, P₂O₅ at 15 to 25 wt % and ZnO at 10 to 30 wt % in terms of oxide.

According to the present invention, by making the most of crystal particles and applying them to either one or both of a spacer surface and a spacer fixing frit, the contamination and deterioration of electron emitters by the migration and diffusion of elements constituting the spacer fixing frit can be suppressed and the decrease in the image quality caused by this can be improved.

Other objects, features and advantages of the invention will become apparent from the following description of the embodiments of the invention taken in conjunction with the accompanying drawings.

### BRIEF DESCRIPTION OF THE SEVERAL VIEWS OF THE DRAWING

FIG. 1 is a schematic plan view describing mainly a constitution of a flat panel display according to Examples of the present invention;

FIG. 2 is a perspective view showing specifically a whole structure example of the flat panel display shown in FIG. 1;

FIG. 3 is a sectional view along A-A′ in FIG. 2;

FIG. 4 is a schematic view describing an arrangement and form of a spacer in an image display in the present invention;

FIG. 5 is a diagram collectively showing semiconductor crystal particles coated on a spacer, spray coated film thicknesses, surface roughnesses Ra and surface resistances at room temperature and 80° C.;

FIG. 6 is a view showing the positional relation of a spacer position and electron emitters whose Ie was evaluated;

FIG. 7 is a diagram showing evaluation results of Ie;

FIG. 8 is a diagram showing evaluation results obtained by analyzing, by the TOF-SIMS method, ingredients of a spacer fixing glass which had diffused to electron emitters in the vicinity of spacers;

FIG. 9 is an illustrative view of a field emission display; and

FIG. 10 is an illustrative view showing a fixed part of a spacer and a front panel.

### DESCRIPTION OF SYMBOLS

100 rear substrate
110 electron emitter
150 spacer
155 oxide crystal particles
200 front substrate
210 phosphor layer
220 anode
230 light shielding layer (black matrix)
300 sealing frame
310 sealing glass frit
401 first glass substrate
402 second glass substrate
403 adhesive layer

### DETAILED DESCRIPTION OF THE INVENTION

Hereinafter, preferred embodiments of the present invention will be described in detail referring to the drawings. In the following description, a front substrate is also referred to as a panel.

A flat panel display described in the following examples is only an example, and the present invention can also be applied to various types of flat panel displays using a glass plate on which wiring is formed, such as displays of electron emission type or field emission type using thin film electron emitters, and plasma displays.

### EXAMPLE 1

In this example, a constitution of a flat panel display will be described.

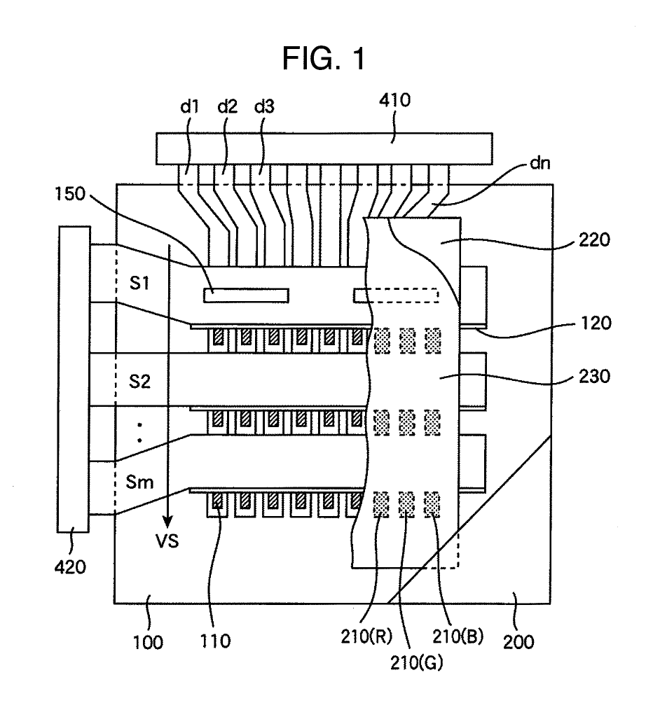

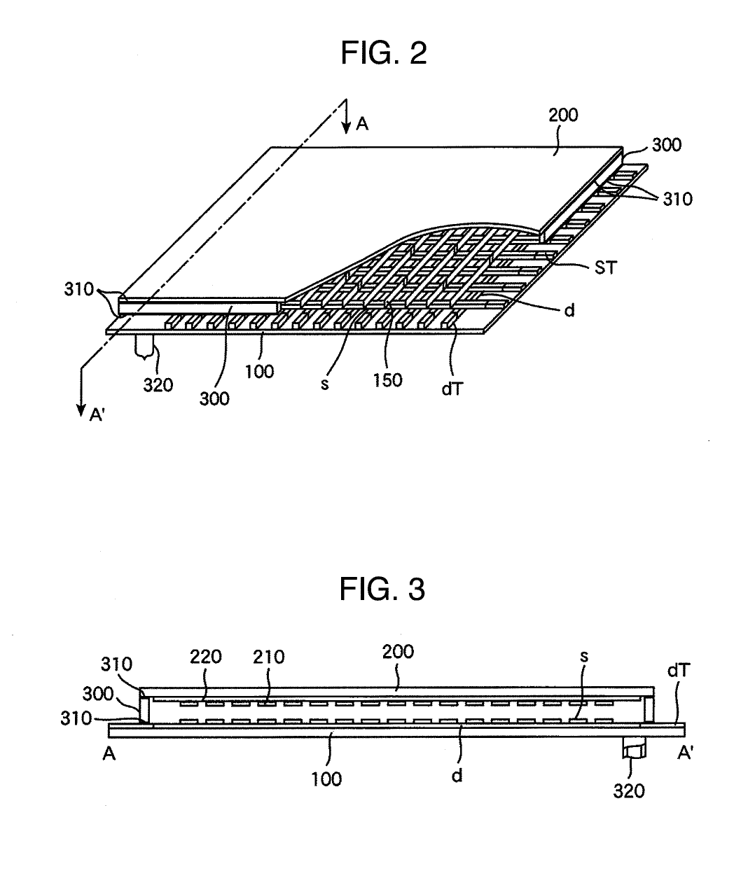

FIG. 1 is a schematic plan view describing a flat panel display. FIG. 2 is a perspective view showing more specifically a whole structure example of the flat panel display shown in FIG. 1. FIG. 3 is a sectional view along A-A′ in FIG. 2.

In FIG. 1, FIG. 2 and FIG. 3, image signal wirings d (d1, d2, . . . dn) are formed on the inner surface of a rear substrate 100, and scanning signal wirings S (S1, S2, S3, . . . Sm) are crossingly formed thereon. Electron emitters 110 are fed with power through connection electrodes 120 from the scanning signal wirings S (S1, S2, S3, . . . Sm). Reference character “VS” denotes the vertical scanning direction.

A front substrate 200 is a little smaller than the rear substrate 100. Wirings dT which are lead out terminals of the image signal wirings d and wirings ST which are lead out terminals of the scanning signal wirings S are formed on marginal surfaces of the rear substrate 100 jutting out from the front substrate 200. Phosphor layers of three colors 210 (210(R), 210(G) and 210(B)) are formed on the inner surface of the front substrate 200, and anode 220 is formed thereon. Reference numeral 410 denotes an image signal line drive circuit; and 420 denotes an operational signal line drive circuit.

In this example, the phosphor layers 210 (210(R), 210(G) and 210(B)) are partitioned by a light shielding layer (black matrix) 230. Here, the anode 220 is illustrated as a solid electrode, but may be a stripe-shaped electrode which crosses the scanning signal wirings S (S1, S2, S3, . . . Sm) and is divided electrodes for every pixels column.

Electrons emitted from each electron emitter 110 are accelerated and impinged on each phosphor layer 210 (210(R), 210(G) or 210(B)) constituting a corresponding subpixel. Thereby, each phosphor layer 210 emits light of a predetermined color and the color is mixed with emitted light colors of the other subpixels, thus constituting color pixels of predetermined colors.

As shown in FIG. 2 and FIG. 3, the rear substrate 100 and the front substrate 200 are integrated with a sealing frame 300 surrounding a display region. The rear substrate 100, the front substrate 200 and the sealing frame 300 are integrated using a sealing glass frit 310.

As described in FIG. 1, inside the sealing region of the inner surface of the rear substrate 100, a large number of the electron emitters 110 are provided in the display region constituted of a matrix of the image signal wirings d (d1, d2, d3, . . . dn) and the scanning signal wirings S (S1, S2, S3, . . . Sm). The wirings dT and the wirings ST are led out to the outside beyond the sealing region which is a part where the sealing frame 300 is installed.

On the other hand, on the inner surface of the front substrate 200, the anode 220 and the phosphor layers 210 are formed as films. As the anode 220, an aluminum layer is generally used. A power feed line of the anode 220 reaches the rear substrate 100 through a connection conductor between the substrates, not shown in the figure, and is led out as a lead out terminal (wiring) from an appropriate part of the rear substrate 100 to the outside of the sealing region which is a part where the sealing frame is installed.

The inner surfaces of the front substrate 200 and the rear substrate 100 face each other and the periphery of the substrates are fixed using the sealing glass frit 310 such that an internal space interposed between both the substrates is isolated from the outside. When the fixation using the sealing glass frit 310 is carried out, heating at about 400° C., for example, is conducted. Thereafter, the interior of the display is evacuated to about 1 μPa through an exhaust pipe 320 and then sealed up. In the operation, a voltage of about 2 to 10 kV is applied to the anode 220 of the front substrate.

In the display of this example, a structure using MIM for the electron emitters is adopted as an example, but the present invention is not limited thereto and as described above, the present invention can be applied similarly to flat panel displays using any of various electron emitters.

A constitution may be adopted in which the front substrate 200 is made of a brim-shaped dish shape in which a brim bent and protruded from the periphery thereof toward the rear substrate 100 side is formed, and a frit glass is applied on the contacting part of the brim and the rear substrate to seal both the substrates. In this case, the application of the frit glass is on the rear substrate side only.

Spacers 150 to hold a gap between the rear substrate and the front substrate are fixed using the front substrate 200 and a spacer fixing glass. The spacers are fixed to the rear substrate 100 by using the spacer fixing glass, or are brought into contact thereto by directly pressing the spacers on the scanning signal wirings S without using the spacer fixing glass.

### EXAMPLE 2

In Example 2, an example of a case where crystal particles are applied on a spacer surface will be in detail described.

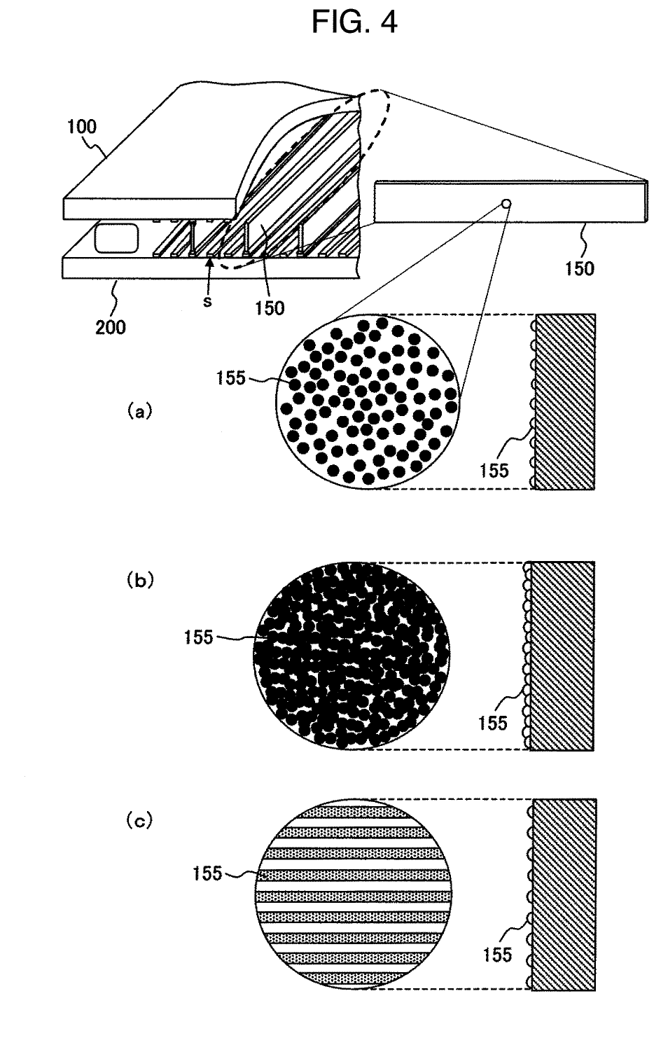

FIG. 4 is a schematic view shown to describe an arrangement and form of a spacer. Oxide crystal particles 155 are fixed on the side surfaces of the spacer 150.

The attachment form of the oxide crystal particles 155 may be a form (FIG. 4(A)) in which the particles are dispersedly arranged like isolated islands, a form (FIG. 4(B)) in which the particles cover the whole spacer 150, or a form (FIG. (C)) in which the particles are attached like continuous stripes.

When the spacers are fabricated by a drawing process of a glass preform, the oxide crystal particles are previously provided on a glass preform, and the preform is drawn to obtain the spacers having the oxide crystal particles on their surfaces.

The spacer used in this example is a glass spacer of 3 mm in width, 100 μm in thickness and 100 mm in length obtained by drawing a glass containing 20 wt % of V₂O₅, 30 wt % of P₂O₅, 30 wt % of WO₃ and 20 wt % of BaO by the redrawing method.

A spacer fixing glass was a glass containing 62 wt % of V₂O₅, 25 wt % of P₂O₅, 3 wt % of WO₃, 5 wt % of BaO and 5 wt % of Sb₂O₃.

The starting raw materials of these glasses were V₂O₅ (made by Kojundo Chemical Laboratory Co., Ltd., purity: 99.9%), WO₃ (made by Kojundo Chemical Laboratory Co., Ltd., purity: 99.9%), BaCO₃ (made by Kojundo Chemical Laboratory Co., Ltd., purity: 99.9%), P₂O₅ (made by Kojundo Chemical Laboratory Co., Ltd., purity: 99.9%) and Sb₂O₃. (made by Wako Pure Chemical Industries, Ltd., purity: 99.9%).

The oxide crystal particles to be coated on the glass spacers were an oxide powder, a vanadic phosphoric acid-based crystallized glass and the like. A vanadic phosphoric acid-based glass powder was adopted as a comparative example.

In this example, studies were conducted using the spray atomizing method with which spacers having oxide crystal particles on their surface were easily fabricated. The particles of each kind were pulverized to an average particle size of 0.1 μm and mixed with a solvent PGME in a proportion of 3% in terms of solid content to make spray atomizing liquids.

The spray atomizing liquid was sprayed on the spacers to fabricate spacers coated in different thicknesses. The spacers after the spray coating were baked in the atmosphere at 460° C. for 30 min to adhere the oxide crystal particles attached on the spacer surfaces by using a glass.

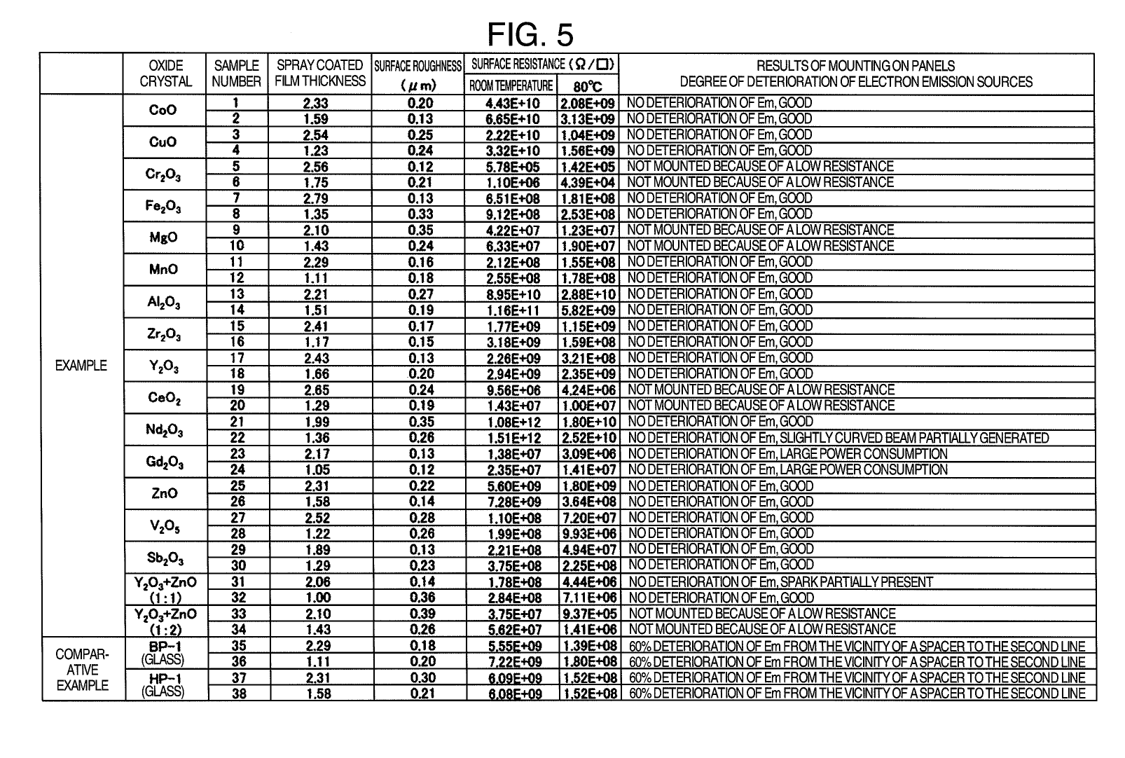

Oxide crystal particles used in the various kinds of spray atomizing liquids fabricated for spray coating and spray atomizing conditions, and results of evaluations of spray coating thicknesses, surface roughnesses Ra and surface resistances at room temperature and at 80° C. are collectively shown in FIG. 5.

Out of these spacers, spacers having a surface resistance of not less than 10⁸ Ω/□ were fixed on the scanning wirings S of the front substrate by using the spacer fixing glass to fabricate flat panel displays shown in FIG. 1. Each of five kinds of the spacers shown in FIG. 5 was mounted on one panel. The spacers of sample number 5, 6, 9, 10, 19, 20, 33 and 34 had a low surface resistance, so if they were mounted on a panel, an overcurrent would flowed, therefore, they were not used in this example.

A voltage of 10 kV was applied to the panels to light and the deterioration of the electron emitters EM due to a long-time lighting was observed.

By 10-hour lighting, in the panels using some spacers, the image luminance in the vicinity of the spacers became dark and shadows of the spacers were observed. The results are collectively shown in FIG. 5. After the 10-hour lighting, the degree of the deterioration of the electron emitters Em did not change with time, and the result of continued lighting tests till 144 hours exhibited no large difference form those after 10 hours.

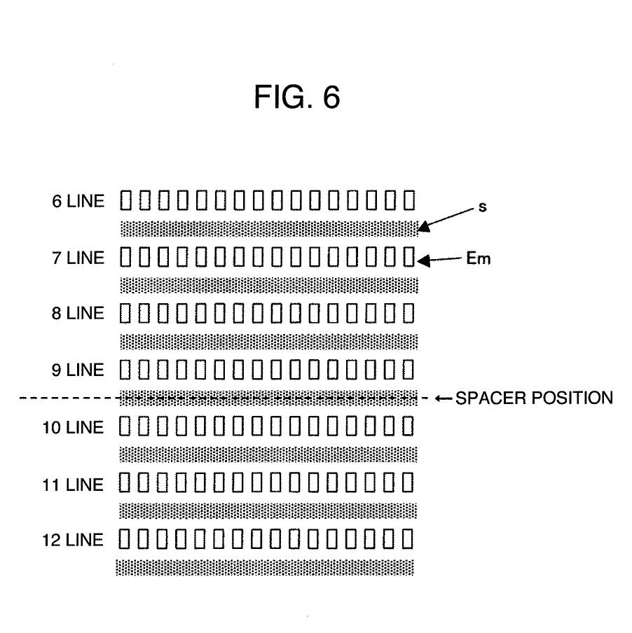

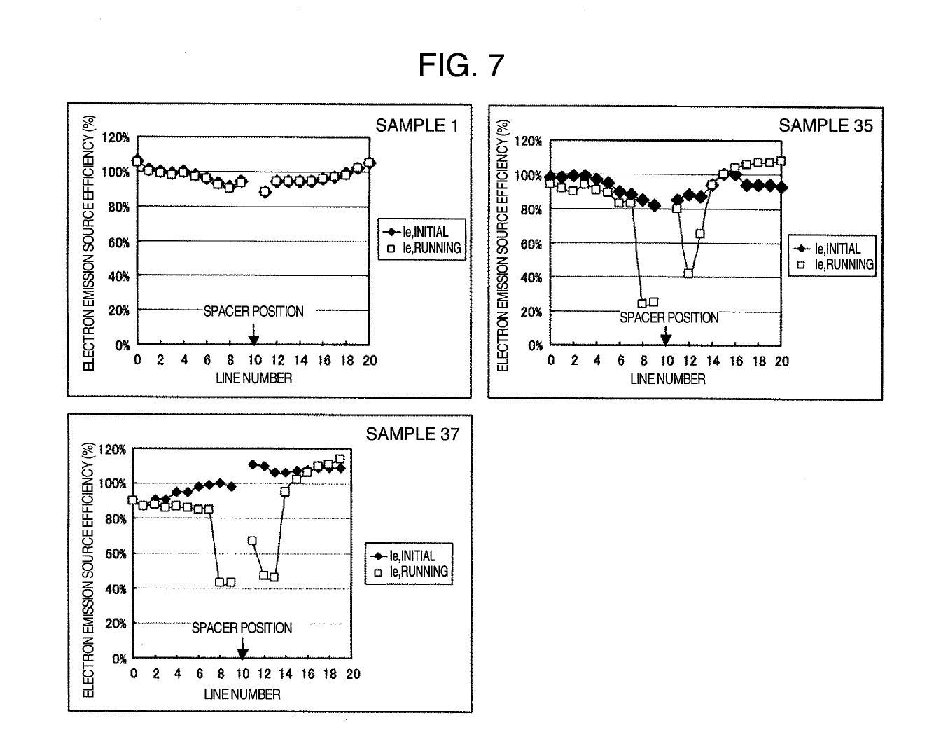

Out of these samples, two samples having the most severe deterioration of the electron emitters and one sample having no deterioration were chosen and currents flowing in the electron emitters and emission currents Ies were measured. Ie right after a voltage of 10 kV was applied to the panels for lighting and Ie after 10-hour lighting were evaluated. The positional relation of the spacer positions and the electron emitters whose Ies had been evaluated is shown in FIG. 6 and the evaluation results of Ies are shown in FIG. 7.

The panels were disassembled and analyzed for ingredients of the spacer fixing glass having diffused in the electron emitters in the vicinity of the spacers by the TOF-SIMS method, and vanadium and phosphorus were detected from the first lines of the vicinity of the spacers. Vanadium and phosphorus were detected from the second and successive lines though decreasing gradually.

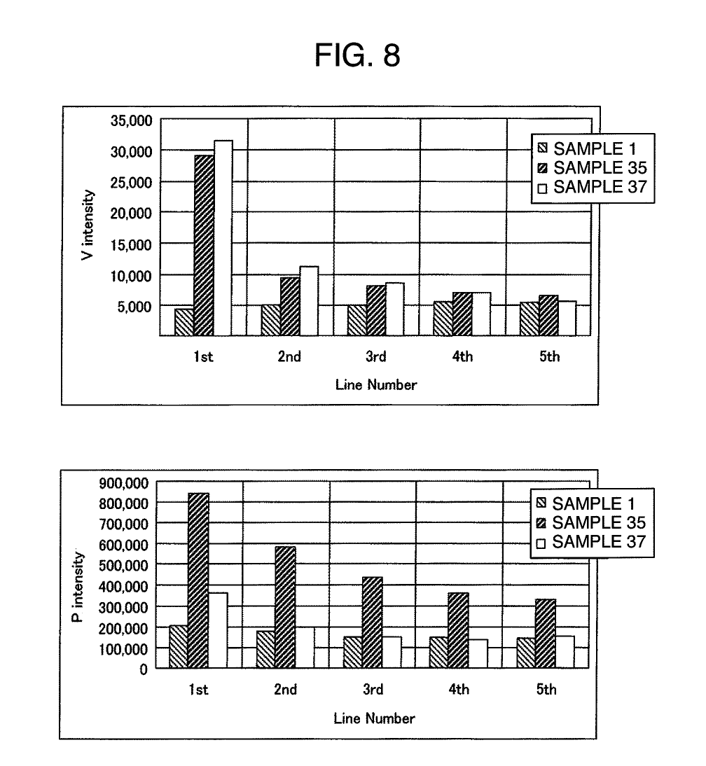

By contrast, the samples in which the deterioration of the electron emitters Em was not confirmed had no detection of vanadium and phosphorus in the vicinity of the spacers. The evaluation results by the TOF-SIMS method are shown in FIG. 8.

That is, the panels on which the spacers coated with the oxide crystal particles on their surface were mounted exhibited no deterioration of the electron emitters.

Separate studies on panels on which the spacers coated with a crystallized glass obtained by crystallizing a vanadic phosphoric acid glass exhibited good results and no deterioration of the electron emitters. That is, as a coating for preventing deterioration of electron emitters, coating of a crystal or a crystallized glass is effective, and the contamination of electron emitters by a spacer fixing glass can be thereby prevented.

The spacers which otherwise were not allowed to be mounted on a panel are allowed to be mounted by fitting the surface resistance to not less than 10⁸ Ω/□ by adjusting the coating film thickness.

This example used a WO₃—V₂O₃—P₂O₅ glass as a spacer material and a V₂O₃—P₂O₅ glass as a spacer fixing glass, but the present invention is not essentially limited to these types of glasses.

### EXAMPLE 3

In Example 3, an example in which crystal particles were applied to a spacer fixing frit will be in detail described.

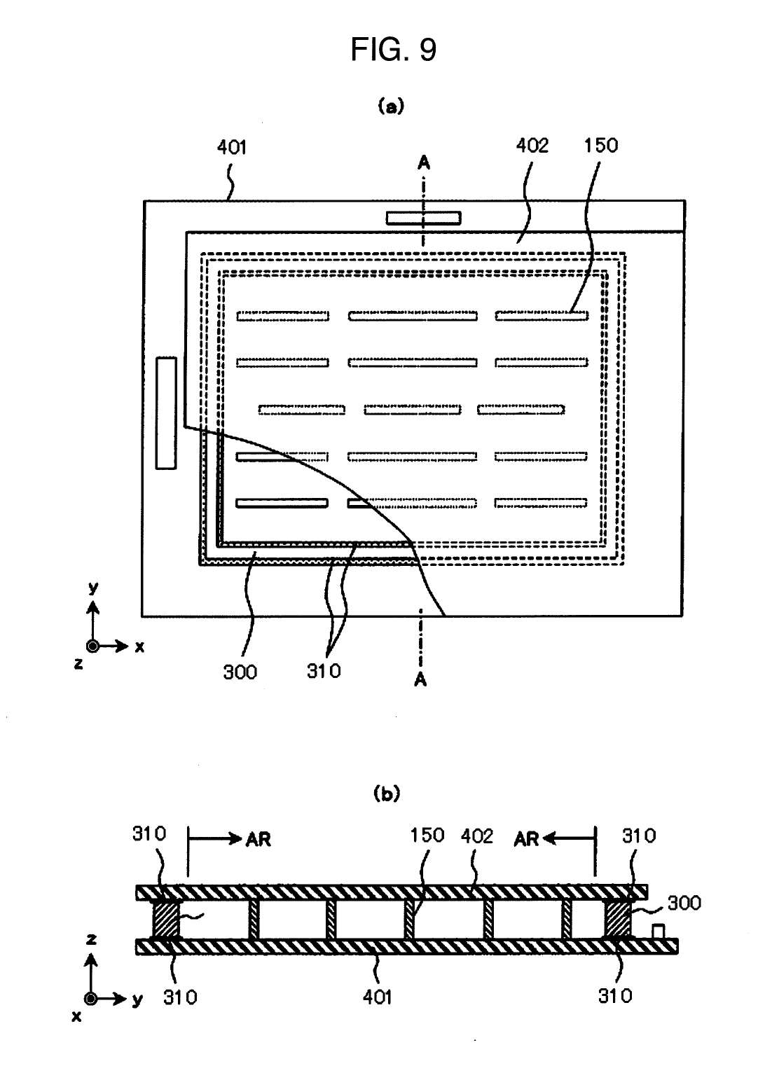

FIG. 9 is a view showing a whole structure of a display of an example of the present invention. Wiring circuits and phosphors are provided similarly to those described in FIGS. 1 to 3, though depicted simply. This display is an electron emission type display obtained by forming a closed container by integrating a rear panel in which thin electron emitters are formed on a first glass substrate 401 and a front panel in which phosphors and an anode are formed on a second glass substrate 402 with a sealing glass frame 300. FIG. 9(A) shows a plan view from the second glass substrate side constituting the front panel and FIG. 9(B) shows a sectional view taken along A-A line of the front panel.

This display is configured with the rear panel and the front panel facing each other with a predetermined gap. The rear panel had the first glass substrate 401 on the inner surface of which a large number of electron emitters (cathode) are formed. The front panel has the transparent second glass substrate 402 in which the phosphors of plural colors which are partitioned from one another with a black matrix film and the anode are formed on the inner surface of the second glass substrate 402 facing the cathode-formed surface of the first glass substrate 401.

The first glass substrate 401 and the second glass substrate 402 face each other with a predetermined gap through spacers 150 being gap holding members. The spacers 150 are adhered and fixed to the second glass substrate 402 by adhering a part of or the entire of the contacting interface by an adhesive layer comprising a conductive glass. The other end surfaces, i.e., the end surfaces contacting with the first glass substrate, of the spacers 150 are pressed and abutted on the first glass substrate without using an adhesive.

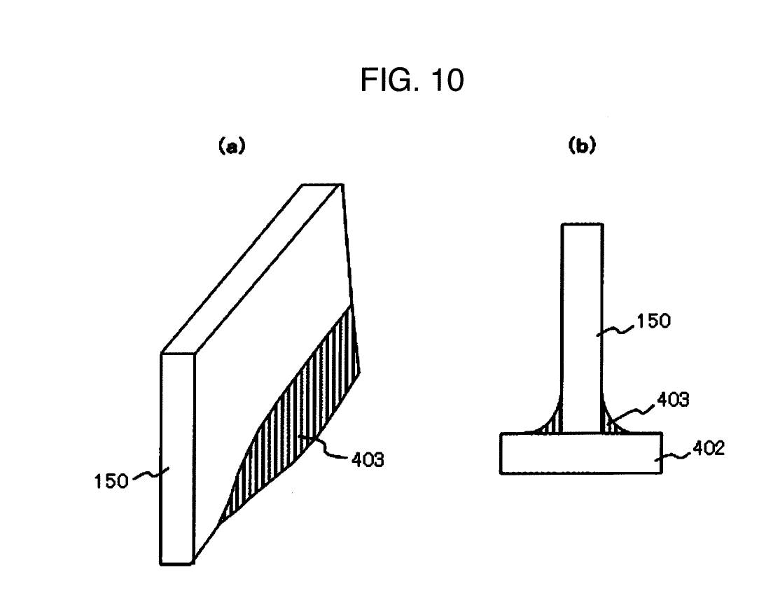

FIG. 10 shows a fixing part of a spacer 150 and the second glass substrate 402. FIG. 10(A) shows a state in which an adhesive layer 403 comprising a glass containing a crystal phase is formed on a part of the end surface of the spacer 150. FIG. 10(B) shows the sectional view. The entire of the contacting surface of the spacer 150 with the second glass substrate may be adhered with the second glass substrate 402, but only a part of the contacting surface may be adhered by the adhesive layer 403 as shown in FIG. 10(A).

Since very sensitive elements are arrayed on the cathode side, the frit to fix the spacers is not used and a state in which the spacers are pressed on is adopted.

The adhesive layer (sealing frit glass) 105 is applied on the inner peripheral parts of the first glass substrate 401 and the second glass substrate 402 and the substrates with the sealing glass frame 300 interposed therebetween are baked and fixed to from the closed container. The interior of the closed container is evacuated through an exhaust pipe not shown in the figure. Images are displayed in a display area AR.

A method of fixing the spacer to the second glass substrate by using an adhesive will be described.

An adhesive constituting the adhesive layer 403 in FIG. 10 is desirably used in a form of a glass frit comprising flakes or a powder in view of simplifying the work. The glass frit is used in a form of a glass paste obtained by mixing the glass frit with a solvent such as ethanol or water and a binder such as an organic compound. The frit can be made to be a liquid by mixing with a solvent. The binder is one which can maintain the coating shape when the paste is applied and dried. The proportion of the solvent and the binder can be suitably changed, but the solvent is 20 to 30% and the binder is not more than 10% to the total paste.

A glass frit contains ingredients constituting a glass and ingredients constituting a crystal phase, and besides these, it can be further mixed with fillers. The fillers are those which improve various characteristics of the adhesive such as thermal expansion coefficient, sealing temperature, electric resistance value and wettability with members constituting a display. The proportion of a sealing glass and fillers contained in a glass frit can be adjusted according to the purposes, but it is preferable that the sealing glass be 20 to 90 vol % and the fillers are 10 to 80 vol %. Plural kinds of fillers having different properties such as thermal expansion coefficient can be together used. The fillers are preferably granular metals and inorganic oxides. Inorganic oxides include, for example, SiO₂, ZrO₂, Al₂O₃, ZrSiO₄, cordierite, mullite and eucryptite. The particle size of fillers is preferably in the range of 0.5 to 10 μm, especially preferably 1 to 5 μm. Mixing of such small filler particles or increasing the filler amount can prevent the adhesive from being sucked in due to the interior reduced-pressure condition when the adhesive is heated and adhered, because the viscosity of the adhesive increases.

The fillers can be used as a mixture of plural kinds according to characteristics of interest. SiO₂ is effective for adjusting the thermal expansion coefficient because it has a smaller thermal expansion coefficient than glasses comprising vanadium and phosphorus as main ingredients. Al₂O₃ can reduce the cost by adjusting the viscosity by mixing or increasing the adhesive amount because Al₂O₃ has the nearly same thermal expansion coefficient as glasses comprising vanadium and phosphorus as main ingredients. Mixing a filler like crystalline particles having a higher thermal conductivity than a sealing glass can raise the thermal conductivity of an adhesive and make adhesion easier.

An example of a method of using the glass adhesive described above when a spacer is fixed to a glass substrate, for example, at 450° C. will be described hereinafter.
(1) A glass paste is prepared and is applied on the peripheral part of a substrate by a dispenser.
(2) The paste is dried (for example, heated to a temperature of 250° C.) and a solvent is removed.
(3) The paste is temporarily baked (for example, at 460° C.) to remove the binder and melt the glass.
(4) A spacer is mounted and baked (for example, 450° C.) to fix the spacer.

The glass adhesive described above is not limited to the usage as an adhesive for fixing a spacer to a glass substrate, and can be widely used as an adhering frit glass.

In this example, the spacers 150 were fixed to a front panel by using the glass frit of the present invention as follows.

The compositions of the glass frits are shown in Table 1. The glass to become a base material was fabricated as follows.

TABLE 1

| | | | Results by X-ray diffraction | | | Electric | Content of | |
|---|---|---|---|---|---|---|---|---|
| Sample | Base Glass | ZnO | Glass | V₂O₅ | | Resistivity | Crystal phase | |
| Number | (wt. %) | (wt. %) | Phase | V—Sb—O | Zn₃(PO₄)₂ | (Ωcm) | (vol. %) | Remarks |
| ZSZ-261 | 100 | 0 | ⊚ | X | X | 5.3 × 10⁷ | 0 | contamination of spacers and |
| | | | | | | | | electron emission sources |
| ZSZ-262 | 95 | 5 | ⊚ | Δ | Δ | 3.0 × 10⁶ | 21 | contamination of spacers and |
| | | | | | | | | electron emission sources |
| ZSZ-263 | 92 | 8 | ◯ | Δ | Δ | 8.8 × 10⁴ | 35 | contamination of spacers and |
| | | | | | | | | electron emission sources |
| ZSZ-264 | 90 | 10 | ◯ | ◯ | ◯ | 5.6 × 10³ | 51 | good |
| ZSZ-265 | 88 | 12 | ◯ | ◯ | ⊚ | 4.2 × 10² | 62 | good |
| ZSZ-266 | 85 | 15 | ◯ | ⊚ | ⊚ | 3.8 × 10² | 75 | good |
| ZSZ-267 | 82 | 18 | ◯ | ⊚ | ⊚ | 4.1 × 10² | 85 | good |
| ZSZ-268 | 80 | 20 | Δ | ⊚ | ⊚ | 3.3 × 10² | 90 | good |
| ZSZ-269 | 77 | 23 | Δ | ⊚ | ⊚ | 3.2 × 10² | 93 | good |
| ZSZ-270 | 75 | 25 | X | ⊚ | ⊚ | 2.8 × 10² | 98 | insufficient adhesive force |
| | | | | | | | | of spacers |
| ZSZ-271 | 70 | 30 | X | ⊚ | ⊚ | 3.1 × 10² | 100 | insufficient adhesive force |
| | | | | | | | | of spacers |

The starting raw materials of these glass base materials were V₂O₅ (made by Kojundo Chemical Laboratory Co., Ltd., purity: 99.9%), BaCO₃ (made by Kojundo Chemical Laboratory Co., Ltd., purity: 99.9%), P₂O₅ (made by Kojundo Chemical Laboratory Co., Ltd., purity: 99.9%), ZnO (made by Kojundo Chemical Laboratory Co., Ltd., purity: 99.9%) and Sb₂O₃ (made by Wako Pure Chemical Industries, Ltd., purity: 99.9%). ZnO reacts with phosphorus in the glass ingredients on fixation of the spacers to form zinc phosphate and to deposit as a crystal phase.

The mixing proportion of the raw materials other than ZnO was 50 wt % of V₂O₅, 20 wt % of P₂O₅, 20 wt % of Sb₂O₃ and 10 wt % of BaO. BaCO₃ was mixed by converting the corresponding amount of BaO taking into consideration of the decomposition into BaO+CO₂. Each raw material was pulverized so as to have an average particle size of 1 μm.

First, the raw materials other than P₂O₅ and ZnO were mixed. This is because since P₂O₅ has a high hygroscopicity, it is not left in the air for a long time. The mixed powder other than P₂O₅ and ZnO was charged in a platinum crucible and was put on a balance together with the crucible. Then, P₂O₅ of a predetermined amount was weighed and mixed with the mixed powder by a metal-made spoon. At this time, for avoiding moisture absorption from the air, mixing using a mortal or a ball mill was not performed.

The platinum crucible charged with the raw material mixed powder was installed in a glass melting furnace and started to be heated. The temperature rising rate was set at 5° C./min and the temperature was kept for 1 hour after a target temperature was reached. In this example, the target temperature was fixed at 1,000° C. The melted glass was held for 1 hour while stirred, and after the holding, the platinum crucible was taken out the melting furnace and the melted glass was pored in a graphite mold to quench the melted glass.

Thermal characteristics of the obtained glass are shown in Table 2. The temperature on fixing the spacers using the glass frit was set at 450° C. in consideration of the softening temperature of the glass.

TABLE 2
Thermal Characteristics of Base Glass

| | | | | | | | | | | Thermal |
|---|---|---|---|---|---|---|---|---|---|---|
| | | | | DTA Analysis Results | | | | | | Expansion |
| Composition Table | | | | | | | | Crystallization | Crystallization | Coefficient |
| V₂O₅ | P₂O₅ | BaO | Sb₂O₃ | Tg | Mg | Ts | Tf | Initiation | Peak | α (250° C.) |
| 50 | 20 | 10 | 20 | 345 | 365 | 415 | 475 | 520 | 585 | 84.6 |

The obtained glass base material was pulverized to an average particle size of 5 μm (maximum particle size: 10 μm), and then, ZnO (average particle size: 1 μm) to crystallize the glasses was mixed in the proportions shown in Table 1.

The mixed powders were each shaped into 10 mm in diameter and 5 mm in thickness, heat-treated at 450° C. for 30 min, and generated crystal phases were identified by an X-ray diffractometer. As a result, it was found that the sample added with more ZnO had a larger proportion of the generated crystal phase, that is, a less amount of the glass remained in the glass frit.

The mixed powder, a solvent and a binder were mixed to be made into a paste, and the paste was applied as a glass frit for fixing spacers when a panel shown in FIG. 9 was fabricated. The solid content of the paste was 75 wt %. The paste was applied on a front panel and spacers were temporarily fixed, and then, the applied paste was baked in the atmosphere at 450° C. for 30 min to fix the spacers. At this time, the spacers which used the pastes of ZSZ-270 and ZSZ-271 were not sufficiently fixed and some of them dropped off. This is because since too many crystal phases were generated in the glass frit, glass ingredients attributable to adhesion did not remain. Hence, the upper limit of the content of crystal phases is preferably 95 vol %.

A display having a structure shown in FIG. 9 in which the spacers were fixed on the front panel by using the glass frit, and contacted with a rear panel without using an adhesive was lit. As a result, the sample using a paste of a less loading amount of ZnO exhibited shadows of the spacers on the screen. After the lighting experiment, the panel was disassembled, and analysis of the spacers and the vicinity of electron emitters detected V and P, which were the constituents of the glass frit, and revealed the contamination of the spacers and the electron emitters due to their diffusion and the deterioration of images.

Further, in the range of the loading amount of ZnO from 10 to 23 wt %, no shadows of the spacers were viewed and a display providing high-quality images could be obtained.

In this example, although ZnO was used as an ingredient to react with a part of glass ingredients and deposit crystal phases, MgO may be used instead. MgO reacts with phosphorus in glass ingredients and forms magnesium phosphate, and the magnesium phosphate deposits as crystal phases. However, since magnesium phosphate has a higher crystallization temperature than zinc phosphate, when MgO is used, a higher heating temperature is necessary on fixing spacers than in the case of using ZnO. Further, use of ZrO₂ in place of ZnO gives the similar effect.

In this example, a glass base material of 50 wt % of V₂O₅, 20 wt % of P₂O₅, 20 wt % of Sb₂O₃ and 10 wt % of BaO was used, but it is not limited thereto.

It should be further understood by those skilled in the art that although the foregoing description has been made on embodiments of the invention, the invention is not limited thereto and various changes and modifications may be made without departing from the spirit of the invention and the scope of the appended claims.

1. An image display comprising a rear substrate, a front substrate corresponding to the rear substrate, and a spacer provided between the substrates and holding a gap, wherein a glass comprising crystal particles is used for either one of the spacer and a glass for fixing the spacer.

2. The image display according to claim 1, comprising: a rear substrate provided on an inner surface thereof with electron emitters; a front substrate facing the rear substrate, provided on an inner surface thereof with phosphor layers having an array corresponding to the electron emitters, and having an outer surface serving as a display surface; glass-made spacers holding a gap between the rear substrate and the front substrate and adhered at least to the inner surface of the front substrate by using a spacer-fixing frit; and a sealing frame sealing a periphery of a spatial part between the rear substrate and the front substrate,
wherein oxide crystal particles are provided on a surface of the spacer.

3. The image display according to claim 2, wherein the oxide crystal particles are fixed on the surface of the spacer by a glass.

4. The image display according to claim 2, wherein at least 90% of the oxide crystal particles comprises particles having a particle size of not less than 0.1 μm and not more than 50 μm.

5. The image display according to claim 2, wherein the spacer surface has a covering rate by the oxide crystal particles of 10 to 100%.

6. The image display according to claim 2, wherein the spacer surface on which the oxide crystal particles are fixed has a surface roughness of not less than 0.1 μm and not more than 50 μm.

7. The image display according to claim 2, wherein the oxide crystal particles comprise oxides containing vanadium and phosphorus, respectively.

8. The image display according to claim 2, wherein the oxide crystal particles comprise at least one selected from the group consisting of CoO, CuO, Fe₂O₃, MnO, Zr₂O₃, Y₂O₃, Nd₂O₃, Gd₂O₃, ZnO, V₂O₅ and Sb₂O₅.

9. The image display according to claim 2, wherein the spacer having the oxide crystal particles on the surface thereof has a surface resistance in the range of 10⁸ to 10¹² Ω/□.

10. The image display according to claim 1, wherein the image display is a field emission display comprising a rear panel comprising a glass substrate on which electron emitters are formed, a front panel comprising a glass substrate on which phosphors are printed, and a plurality of spacers arranged between the front panel and the rear panel, wherein the spacers are conductive and at least partially fixed to the front panel by an adhesive layer comprising a glass a part of which is crystallized.

11. The image display according to claim 10, wherein the adhesive layer comprising a glass contains 50 to 95% by volume of crystal phases.

12. The image display according to claim 10, wherein the glass constituting the adhesive layer has an electric resistivity of not more than 10⁹ Ωcm.

13. The image display according to claim 10, wherein at least partially fixed to the front panel by a frit glass comprising glass constituents and a crystallizing component that reacts with a part of the glass constituents and forming crystal phases.

14. The image display according to claim 10, wherein the glass constituting the adhesive layer contains V₂O₅ as a main component.

15. The image display according to claim 10, wherein the glass constituting the adhesive layer contains 50 to 60% by weight of V₂O₅, 15 to 25% by weight of P₂O₅, and 10 to 30% by weight of ZnO in terms of oxide.

16. A spacer for an image display, the glass-made spacer holding a gap between a rear substrate and a front substrate in the image display, wherein oxide crystal particles are fixed on a surface of the spacer.

17. The spacer for an image display according to claim 16, wherein at least 90% of the oxide crystal particles comprises particles having a particle size of not less than 0.1 μm and not more than 50 μm.

18. The spacer for an image display according to claim 16, wherein the spacer surface has a covering rate by the oxide crystal particles of 10 to 100%.

19. The spacer for an image display according to claim 16, wherein the spacer has a surface roughness of not less than 0.1 μm and not more than 50 μm in a state in which the oxide crystal particles are fixed.

20. The spacer for an image display according to claim 16, wherein the oxide crystal particles comprise oxides containing vanadium and phosphorus, respectively.

21. The spacer for an image display according to claim 16, wherein the oxide crystal particles comprise at least one selected from the group consisting of CoO, CuO, Fe₂O₃, MnO, Zr₂O₃, Y₂O₃, Nd₂O₃, Gd₂O₃, ZnO, V₂O₅ and Sb₂O₅.

22. The spacer for an image display according to claim 16, wherein the spacer has a surface resistance in the range of 10⁸ to 10¹² Ω/□ in a state in which the oxide crystal particles are fixed on a surface thereof.

23. A glass frit comprising a conductive glass and a crystallizing component reacting with a part of the conductive glass and forming crystal phases.

24. The glass frit according to claim 23, wherein the glass frit contains 50 to 60% by weight of V₂O₅, 15 to 25% by weight of P₂O₅, and 10 to 30% by weight of ZnO in terms of oxide.
